(19) United States
(12) Patent Application Publication
(10) Pub. No.: US 2011/0206882 A1
(43) Pub. Date: Aug. 25, 2011

(54) INJECTION STRETCH BLOW MOLDING PROCESS

(76) Inventors: Norman Scott BROYLES, Hamilton, OH (US); Emily Charlotte Boswell, Cincinnati, OH (US); Douglas Bruce Zeik, Middletown, OH (US); Patrick Jean-Francois Etesse, Etterbeek, OH (US); John Moncrief Layman, Liberty Township, OH (US)

(21) Appl. No.: 13/033,091

(22) Filed: Feb. 23, 2011

Related U.S. Application Data
(60) Provisional application No. 61/307,555, filed on Feb. 24, 2010.

(51) Int. Cl. B65D 1/02; B29C 45/00; B29C 49/06

(52) U.S. Cl. 428/36.92; 264/328.1; 264/513

(57) ABSTRACT

The present invention relates to a solid preform made from polyethylene material, wherein the preform comprises a neck region, side walls and a base region, and has an interior having inner walls and an exterior having outer walls; characterised in that at least 65% of the polyethylene material by weight of the total polyethylene material has a Z-average molecular weight (Mz) of between 300,000 g/mol and 6,000,000 g/mol, and a Mz/Mn value of greater than 28, where Mn is the number average molecular weight, and Mz/Mn is the Mz value divided by the Mn value.

### CROSS REFERENCE TO RELATED APPLICATION

This application claims the benefit of U.S. Provisional Application No. 61/307,555, filed Feb. 24, 2010.

### FIELD OF THE INVENTION

Injection stretch blow molding is a widely practiced process for the manufacture of bottles which are made from polyester, in particular from polyethylene terephthalate. Such bottles are commonly used, amongst other purposes, for the packaging of soft drinks.

### BACKGROUND OF THE INVENTION

There are a number of advantages of using polyethylene materials to make containers, over other materials. One advantage is that they are readily recyclable and compatible with existing recycling infrastructure, unlike some other materials such as polypropylene. A further advantage is that they are less prone to ‘pH degradation and discoloration’ (cracking and loss of structure) than other materials, such as polyethylene terephthalate, which is sensitive to high pH. This means a wider array of materials having an array of pH's can be stored in the finished container. Another advantage is that containers made of polyethylene materials are more suitable for further downstream processing of the container, such as incorporation of integral handles that require extensive deformation.

Injection stretch blow molding techniques achieve preferential molecular orientation of the polyethylene materials, which exceeds that achievable with traditional methods of producing containers such as extrusion blow molding. This, results in more efficient material utilization due to improved properties such as tensile modulus (a measure of the ‘stiffness’ of an elastic material). For example, the orientation of polyethylene achieved in stretch blow molding may allow a 25% decrease in material usage compared to more traditional processes that do not impart as much molecular orientation. Thus, injection stretch blow molding offers the potential for a more economical and efficient method of making containers.

Injection stretch blow molding comprises the steps of first injection molding the preform, stretching it and then increasing the internal pressure in the stretched preform to produce the final container shape. The preform can also be formed by compression molding or thermoforming.

The ability to injection mold a material at commercial speeds requires a material with good “shear thinning characteristics”. Shear thinning is the typical rheological behavior exhibited when stress is applied to materials while in the melt phase. In other words, the material in the molten state must flow such that it can follow all the contours of the mold and not result in disproportionately thick or thin areas of material.

The ability to stretch a material in a stretch blow mold step requires the material to exhibit “strain hardening”, which is defined as an increase in resistance to stretch with increased extensional deformation. This characteristic ensures good material distribution, so containers are not formed with holes, or areas where the material is stretched too thin. This means that when a material gets to a certain thickness, it resists further extension, so preventing the eventual formation of a hole.

High molecular weight polyethylene materials exhibit strain hardening, and so are suitable for stretch blow molding. Thus, preforms made of high molecular weight polyethylene materials can be stretch blow molded into containers that have good material distribution, and so do not have holes or areas of thin or thick material. However, the use of high molecular weight materials results in poor shear thinning.

High molecular weight polyethylene materials exist and have been used in injection stretch blow molding, as referenced by JP-A-2000/086722, published on Mar. 28, 2000. JP-A-2000/086722 discloses a high density polyethylene resin which is subjected to injection stretch blow molding. Materials of the above description tend to stretch well, due to strain hardening characteristics but will not perform well in injection molding, due to lack of shear thinning characteristics.

Furthermore, plastic parts environmentally stress crack when they are under tensile stress and in contact with liquids containing oxidants and surfactants. In a container, stress cracking occurs only in the regions that are under tensile deformation and in contact with the liquid.

The tensile stress results in the formation of “local crazes” (minute cracks) that become a continuous crack in certain instances. Polyethylene exists as composites of regularly-ordered crystalline segments in a matrix of unordered polymer. Chemically, the two phases are indistinguishable from each other, yet they form separate discrete phases. Tie molecules connect the various crystallites together. As the polyethylene material is under tensile load, the crystallites are under stress and they start moving away from each other as the tie molecules are stretched. Oxidants in the liquid (e.g. bleach) cleave the tie molecules causing earlier failure than when the material is exposed to water or air. Furthermore, surfactants in the liquid act as plasticizers, and lubricate the disentanglement of the tie molecules and their separation from the crystallites (plasticization is the process of increasing the fluidity of a material). The presence of high molecular weight materials provide for good environmental stress crack resistance, as the long chains offer more interaction with the tie molecules. Increasing the amount of lower molecular weight materials in order to achieve shear thinning, will diminish the environmental stress crack resistance.

Therefore, there is a need to provide a preform for making a polyethylene container, wherein the preform is made of a polyethylene material that exhibits both shear thinning characteristics for injection molding and strain hardening for stretch blow molding of an injection stretch blow molding process. There is also a need for the preform to produce a final container that maintains good environmental stress crack resistance. There is also a need to provide a process for making a polyethylene container, wherein the preform is made of a polyethylene material that exhibits both shear thinning and strain hardening characteristics, and also provides good environmental stress crack resistance of the final product.

It was surprisingly found, that preforms made of polyethylene materials having particular molecular weight characteristics solved the above-stated technical problem. The materials exhibit shear thinning characteristics for injection molding, the preforms have good strain hardening properties for during the stretch blow molding step, and the final container has good environmental stress crack resistance.

### SUMMARY OF THE INVENTION

A first aspect of the present invention is a solid preform made from polyethylene material, wherein the preform comprises a neck region, side walls and a base region, and has an interior having inner walls and an exterior having outer walls; characterised in that at least 65% of the polyethylene material by weight of the total polyethylene material has a Z-average molecular weight (Mz) of between 300,000 g/mol and 6,000,000 g/mol, and a Mz/Mn value of greater than 28, where Mn is the number average molecular weight, and Mz/Mn is the Mz value divided by the Mn value.

A second aspect of the present invention is a process for injection molding a solid preform, wherein the solid preform is made from polyethylene material, and wherein the preform comprises a neck region, side walls and a base region, and has an interior having inner walls and an exterior having outer walls; characterised in that at least 65% of the polyethylene material by weight of the total polyethylene material has a Z-average molecular weight (Mz) of between 300,000 g/mol and 6,000,000 g/mol, and a Mz/Mn value of greater than 28, where Mn is the number average molecular weight, and Mz/Mn is the Mz value divided by the Mn value, and the peak pressure during the injection molding process is less than 500 bar.

A third aspect of the present invention is to a process for blow molding a polyethylene container comprising the steps of:
a) providing a solid preform made from a polyethylene material, wherein the preform comprises a neck region, side walls and a base region, and has an interior having inner walls and an exterior having outer walls;
b) optionally reheating the preform so that the maximum temperature difference between the hottest and coldest regions of the side walls and the base region of the reheated preform is less than 4° C.;
c) transferring the preform to a blow mould cavity;
d) stretching the preform at a pressure below 15 bars; and
e) increasing the pressure within the reheated preform so as to cause the walls of the stretched preform to expand to the shape and dimensions inside the blow mould cavity;
   characterised in that at least 65% of the polyethylene material by weight of the total polyethylene material has a Z-average molecular weight (Mz) of between 300,000 g/mol and 6,000,000 g/mol, and a Mz/Mn value of greater than 28, where Mn is the number average molecular weight, and Mz/Mn is the Mz value divided by the Mn value.

### BRIEF DESCRIPTION OF THE DRAWINGS

FIGS. 1A and B show the dimensions of the preforms used in the present invention.

### DETAILED DESCRIPTION OF THE INVENTION

The preform for use in the process of the present invention comprises a neck region, side walls and a base region, thus forming a substantially symmetrical tube on its outer dimensions from a point near the closed end to a point near the open end. The preform has an interior having inner walls and an exterior having outer walls. Preferably, the side walls of the preform, between the neck region and the base region, have substantially straight and parallel outer wall surfaces. It has been found that preform designs with parallel and straight outer walls allow even reheating and even stretching of polyethylene and thus aid the blowing of the final container. Another benefit of parallel straight wall preform designs is that it maximizes the amount of material that can be packed in a given neck design and minimizes stretch ratios (the amount of extension on the material) during the stretch blow molding process. This means that the material in any one given area is not stretched too much, or too little, so allowing for better material distribution in the final container.

The polyethylene materials of the present invention comprise one or more polymer species. Each polymer species of the present invention may be a homopolymer consisting of ethylene monomeric units, or may be a copolymer comprising ethylene units co-polymerized with other monomeric units, preferably C3 to C20 alpha olefins but could include others such as vinyl acetate, maleic anhydride, etc. Therefore, the polyethylene material comprises different polymer species, each polymer species comprising monomeric units of ethylene, C3 to C20 alpha olefins, and other comonomers. Each combination of polymer species exhibits different physical properties, characteristic to that particular polyethylene material. The polyethylene materials of the present invention are also preferably medium density or high density polyethylene. High density polyethylene is defined as having a density of from 0.941 g/cm³ to 0.960 g/cm³. Medium density polyethylene is defined as having a density of from 0.926 g/cm³ to 0.940 g/cm³. In one embodiment, the polyethylene materials of the present invention have a density from 0.926 g/cm³ to 0.960 g/cm³. In another embodiment, the polyethylene materials of the present invention have a density of from 0.926 g/cm³ to 0.940 g/cm³. In yet another embodiment, the polyethylene materials of the present invention have a density of from 0.941 g/cm³ to 0.960 g/cm³.

In one embodiment, the polyethylene material is “bio-sourced PE”, that is, it has been derived from a renewable resource, rather than from oil. In one embodiment, sugar cane is fermented to produce alcohol. The alcohol is dehydrated to produce ethylene gas. This ethylene gas is then put through a polymerization reactor (same type of reactor as used with ethylene gas derived from oil). Bio-sourced polyethylene can be made from other plants and plant materials, for example, sugar beet, molasses or cellulose. Bio-sourced polyethylene has the same physical properties as oil-based polyethylene, providing it has been polymerized under the same reactor conditions as the oil-sourced polyethylene.

It was surprisingly found, that preforms made of at least 65% polyethylene materials having the particular molecular weight characteristics of Mz between 300,000 g/mol and 6,000,000 g/mol and a Mz/Mn of greater than 28 exhibited shear thinning characteristics necessary for injection molding, had good strain hardening properties for during the stretch blow molding step, and the final container had good environmental stress crack resistance.

Within each polyethylene material, the various individual polymer species have a range of degrees of polymerization, and molecular mass. In other words, there is a mixture of long and short chain polymer species, each having a different molecular weight. The distribution is quantified by a series of “average” molecular weight equations. Two common molecular weight averages utilized for polyethylene materials are;
Number Average Molecular Weight, Mₙ, which is the average of the molecular weights of the individual polymer species;
Z-Average Molecular Weight, M_{z}, which is the weight of each polymers species multiplied by the molecular weight of each polymer species.

For a polymer species, Mz of the polymer species in that polyethylene material can be calculated. The Mz value is defined using Equation 1;

$${M}_{z} = \frac{{\sum }_{i = 1}^{\#} {n}_{i} \cdot {MW}_{i}^{3}}{{\sum }_{i = 1}^{\#} {n}_{i} \cdot {MW}_{i}^{2}} \qquad Equation 1$$

MWᵢ is the molecular weight of a particular polymer species, i. nᵢ is the number of that particular species having a MWᵢ and # is the total number of species in the polyethylene material. The above calculation does not include species with MWᵢ less than 1500 g/mol or greater than 7,000,000 g/mol. Low molecular weight species, less than 1500 g/mol, would represent a contaminant and not be favorable for the stretch portion of the process. High molecular weight species, greater than 7,000,000 g/mol, would represent “gel” particles or other unmeltable/unflowable material that would not be conducive to the stretch or injection portion of the process.

For a polymer, the number average molecular weight of that polymer species can be calculated as the number average molecular weight (Mn). The number average molecular weight is defined in Equation 2;

$${M}_{n} = \frac{{\sum }_{i = 1}^{\#} {n}_{i} \cdot {MW}_{i}}{{\sum }_{i = 1}^{\#} {n}_{i}} \qquad Equation 2$$

MWᵢ is the molecular weight of a particular polymer species, i. nᵢ is the number of that particular species having a MWᵢ and # is the total number of species in the polyethylene material. Essentially, Mn is determined by measuring the molecular weight of n polymer molecules, summing (Σ) the weights, and dividing by n. The above calculation does not include species with MWᵢ less than 1500 g/mol or greater than 7,000,000 g/mol, for the reasons stated above.

It can be considered, for the ease of understanding, that the Mz value reflects the amount of high molecular weight polymer species in the polyethylene material. This value thus can be considered to correspond to the strain hardening characteristics of the polyethylene material.

It can be considered, for the ease of understanding, that the Mz/Mn value reflects the ratio of high and low molecular weight polymer species in the polyethylene material. Therefore, this value can be considered to correspond to the shear thinning characteristics of the polyethylene material.

At least 65% of the polyethylene material by weight of the total polyethylene material has a Mz of between 300,000 g/mol and 6,000,000 g/mol and a Mz/Mn of greater than 28. In another embodiment at least 80% of the polyethylene material by weight of the total polyethylene material has a Mz of between 300,000 g/mol and 6,000,000 g/mol and a Mz/Mn of greater than 28. In yet another embodiment, at least 90% of the polyethylene material by weight of the total polyethylene material has a Mz of between 300,000 g/mol and 6,000,000 g/mol and a Mz/Mn of greater than 28.

Preforms comprising at least 65% of materials having a Mz of less than 300,000 g/mol, when stretch blow molded, produced containers with holes in due to the lack of strain hardening. Materials having molecular weights greater than 6,000,000 g/mol are ultra high molecular weigh polyethylenes. Due to their extremely high molecular weights, they produce brittle containers. Therefore, preforms comprising at least 65% of materials having a Mz of more than 6,000,000 g/mol are not suitable.

It was surprisingly found, that in order for the material to produce containers made from the preform which do not have holes (strain hardening), yet also have shearing thinning characteristics necessary for injection molding, the polyethylene materials also needed a Mz/Mn of greater than 28. Having an Mz between 300,000 g/mol and 6,000,000 g/mol, but a Mz/Mn of less than 28 required very high pressures in the injection step. This meaning that their shear thinning characteristics were poor, so requiring high pressure to distribute the material to fill the mold, or they did not fill the mold.

The final containers made from preforms comprising materials having these characteristics also showed good environmental stress crack resistance.

Size exclusion chromatography (SEC), also referred to as gel permeation chromatography (GPC), was used to separate and measure the M_{z}, M_{w} and Mₙ values of the polyethylene materials. The SEC instrument used was a Polymer Laboratories PL-GPC 220 high temperature liquid chromatography system equipped with three Polymer Laboratories 300×7.5 mm PL-Gel mixed-B cross-linked polystyrene columns, a differential refractive index detector, and an inline Wyatt DAWN EOS 18-angle multi-angle laser light scattering detector. The chromatography eluent consisted of liquid chromatography-grade 1,2,4-tricholorbenzene (TCB) stabilized with 0.125 g/L butylated hydroxytoluene (BHT). The eluent was degassed using a Polymer Laboratories PL-DG 802 inline degasser and metered through the liquid chromatography system at 1.0 mL/min. Polyethylene material sample solutions were prepared by dissolving approximately 10-20 mg of the polyethylene material into 5-20 mL of TCB at 150° C. for approximately 24 h. After dissolution, samples were filtered through pre-warmed aluminum frits which had an average pore size of 10 μm. Sample solutions were maintained at 150° C. and then loaded into the PG-GPC 220 system's autosampler for analysis. Since the SEC system was equipped with a mutli-angle laser light scattering detector, calibration with known standards was not required. However, the accuracy and reproducibility of the system was confirmed by running mono- and polydisperse polyethylene standards of known molecular weight. ASTRA®, the equipment software then converts the molecular weight peaks for the different polymer species in each polyethylene material and calculates both the Mz and Mz/Mn values based on equations 1 and 2.

In one embodiment of the present invention, the polyethylene material of the present invention comprises polyethylene materials comprising an additive. The additive is preferably selected from the group comprising pigments, UV filter, opacifier, antioxidants, surface modifiers, processing aids or mixtures thereof. Preferably the additive is a pigment. Surface modifiers are preferably selected from the group comprising slip agents, antiblocks, tackifiers and mixtures thereof. Anti-oxidants are preferably selected from the group comprising primary or secondary anti-oxidants or mixtures thereof. In one embodiment, the additive is a pigment, preferably selected from the group comprising TiO₂ or pacifiers or mixtures thereof. Processing aids are preferably selected from the group comprising waxes, oils, fluoroelastomers or mixtures thereof. In another embodiment, the additives are selected from the group comprising flame retardants, antistatics, scavengers, absorbers, odor enhancers, and degredation agents or mixtures thereof.

In one embodiment of the present invention, the polyethylene material having a Z-average molecular weight (Mz) of between 300,000 g/mol and 6,000,000 g/mol, and a Mz/Mn value of greater than 28, comprises post consumer recycled high density polyethylene. Post consumer recycled means polyethylene materials that have been recycled from discarded consumer products. It is preferred to use these materials as this is more environmentally friendly. However, they often do not exhibit the desired characteristics necessary for them to have the strain hardening and shear thinning characteristics as detailed above. It was surprisingly found that the addition of a polyethylene wax gave the post consumer recycled high density polyethylene the desired molecular weight characteristics (Mz & Mz/Mn) values of the present invention.

Polyethylene waxes are ultra low molecular weight polyethylenes. They typically have an Mz of less than 60,000 and a Mz/Mn of less than 12. The post consumer recycled material typically has a Mz of >500,000 and an Mz/Mn of less than 20.

Preferably, between 1 and 40%, more preferably between 15 and 25% of the polyethylene material having a Z-average molecular weight (Mz) of between 300,000 g/mol and 6,000,000 g/mol, and a Mz/Mn value of greater than 28, comprises a polyethylene wax. Preferably between 40 and 60%, more preferably between 20 and 80%, most preferably between 10 and 90% of the polyethylene material having a Z-average molecular weight (Mz) of between 300,000 g/mol and 6,000,000 g/mol, and a Mz/Mn value of greater than 28, comprises post consumer recycled high density polyethylene material.

Injection stretch blow molding comprises the steps of;
injection molding the preform;
stretching it and then;
increasing the internal pressure in the stretched preform to produce the final container shape.

The polyethylene preform is provided in a first process step. High cavitation injection molding is the process which is currently widely used to produce preforms, however, any suitable process can be used. Injection pressures for polyethylene are, at peak pressures in the order of 500 to 800 bar. Injection is conducted at higher temperatures when the material is in the molten phase. In one embodiment, liquid colourants can be added to the molten polyethylene material. Preferably, the peak injection pressure for the polyethylene materials is less than 500 bar pressure.

In a further process step, the preform is optionally re-heated, preferably in an infrared oven. Re-heating is optional as in at least one embodiment, the preform will not cool sufficiently after the preform manufacturing process for it to require re-heating. Typically, the preform itself is reheated to temperatures of about 120° C. to about 140° C. The maximum temperature difference between the hottest and coldest regions of the side wall and the base region of the reheated preform is preferably less than 4° C., and more preferably less than 2° C. In another embodiment, the temperature difference between the side wall and the base region of the preform was +/−1° C. prior to exiting the oven.

The reheated preform is transferred to a blow mold and firstly stretched and then blow molded. Preferably this preform is stretched by means of a stretch rod. Preferably, the preform is stretched at a speed of greater than 1 m/s. The pressure within the stretched preform is then increased above ambient pressure but below 15 bars, preferably below 10 bars, more preferably below 5 bars, most preferably below 2 bars, so as to cause the walls of the stretched preform to expand to the shape and dimensions inside the blow mold.

At the end of the stretch blow molding process, the finished container is ejected from the blow mold cavity.

Preferably the container made according to the present invention has a minimum wall thickness of the container of 200 micrometers, and the weight to volume ratio of the empty container is less than 50 grams per litre, preferably less than 40 grams per litre, and more preferably less than 30 grams per litre.

Top load resistance is the ability of a container to withstand compressive ‘top’ applied load as found during warehouse storage for example. Two different types of top load resistance can be measured. The first measures the top load needed to cause some kind of displacement of the bottle, for example, bulging sides. The second measures the load needed to cause container failure, for examples the ‘neck’ region collapses or a corner of the container is crushed. This usually causes material failure of the container, such as cracking or splitting of the plastic. The test method and data are presented in the Examples section. Following the injection stretch blow molding process, it takes time before the container can resist its maximum top load, due to continued molecular reorientation. Polyethylene containers produced according to the present invention have the attribute that their resistance to top load/crush is fully developed faster than other materials, such as polypropylene. Consequently polyethylene containers made by the present invention do not require as careful handling after blowing and can be produced at high speed, exceeding 600 containers per hour per mold.

The resulting polyethylene container produced by the process described in the invention exhibits enhanced mechanical properties compared to a polyethylene container produced by the traditional extrusion blow molding process. This means that containers made using the process of the present invention are more resistant to top applied force, e.g as found when containers are stacked in warehouses.

### EXAMPLES

The polyethylene materials of Table 1 were prepared. Materials 1-2 are according to the present invention (100% polyethylene material, no additives), whereas materials A-D are comparative (100% polyethylene material, no additives).

TABLE 1

| Material | Mz | Mz/Mn |
|---|---|---|
| Material 1 | 500,000 | 31.1 |
| Material 2 | 740,000 | 31.2 |
| Material A | 740,000 | 18.8 |
| Material B | 190,000 | 7.9 |
| Material C | 270,000 | 10.9 |
| Material D | 220,000 | 11.4 |

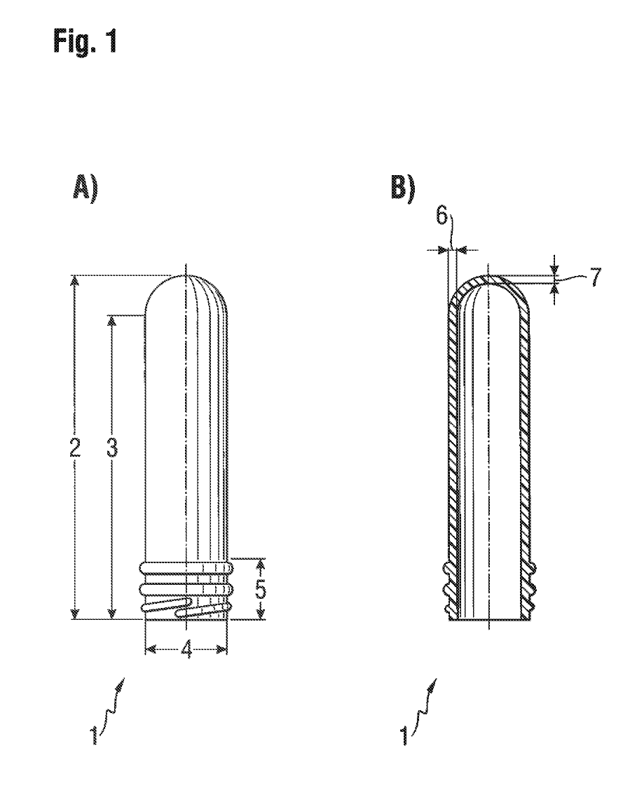

The general shape of performs suitable in the present invention has been described earlier in this application. Referring to FIGS. 1A and 1B, the dimensions of the specific preform 1 as used to collect data to support the present invention are as follows; length 2 is 120.87 mm; length 3 is 118 mm; diameter 4 is 35 mm, length 5 is 19.48 mm, width 6 is 2.7 mm and width 7 is 2.6 mm.

The following aspects were assessed;
1. Shear thinning characteristics of the polyethylene materials of Table 1. This was assessed by using the polyethylene materials of Table 1 to injection mold preforms. The peak injection pressure (maximum pressure required in the injection molding process) was used as an indicator of shear thinning characteristics characteristics. The higher the peak pressure needed, the worse the shear thinning characteristics, as higher pressures are needed to ensure the material distribution within the mold.
2. Strain hardening of preforms made from polyethylene materials of Table 1. This was assessed by stretch blow molding preforms made of polyethylene materials of Table 1. The performance was assessed by checking final containers for the presence of holes, and also wall thickness variability. The presence of holes and poor material distribution is indicative of poor strain hardening, as the materials do not have the ability to resist stretch.
3. The environmental stress crack resistance of the final container made from preforms comprising materials in Table 1. This was assessed by measuring the length of time required for containers filled with detergent and with a load placed on top, before they started to leak.
4. Mechanical properties of the final container made from preforms comprising materials in Table 1. This was assessed using standard method, ASTM International, D2659-95, using a constant speed of compression of 12.7 mm/min. This method assesses the amount of top applied force needed to cause structural failure of the bottle. Containers made using the process of the present invention were compared to containers made using another container making process, extrusion blow molding.

### Injection Molding

The ability to injection mold preforms made of the materials detailed in Table 1, was evaluated by molding preforms of a given geometry detailed in FIGS. 1A and 1B using an Arburg 370C monocavity injection machine. The routine steps necessary to operate the Arburg 370C monocavity injection machine are known to those skilled in the art. The process parameters used for all materials are shown in Table 2. Those skilled in the art would know how to input the following parameters into the Arburg 370C monocavity injection machine.

TABLE 2

| Rate | Rate | Rate | Rate | Rate | | |
|---|---|---|---|---|---|---|
| (cm/s) | Stage #1 | Stage #2 | Stage #3 | Stage #4 | | |
| | 12.5 | 10.0 | 7.0 | 5.0 | | |
| End step | Rate | Rate | Rate | Rate | | |
| (cm) | Stage #1 | Stage #2 | Stage #3 | Stage #4 | | |
| | 26.0 | 18.0 | 10.0 | 0.5 | | |
| Hold | Pressure | Pressure | Pressure | Pressure | Pressure | |
| Pressure | Stage #1 | Stage #2 | Stage #3 | Stage #4 | Stage #5 | |
| (bar) | 350 | 700 | 400 | 300 | 25 | |
| Hold Time | Pressure | Pressure | Pressure | Pressure | Pressure | |
| (s) | Stage #1 | Stage #2 | Stage #3 | Stage #4 | Stage #5 | |
| | 0.0 | 3.0 | 5.0 | 0.5 | 0.5 | |
| Dosage (cm3) | | | 44.0 | | | |
| Back Pressure (bar) | | | 25.0 | | | |
| Decomp. Flow (cm/s) | | | 10.0 | | | |
| Decomp. Vol. (cm3) | | | 1.40 | | | |
| Cycle time (sec) | | | ~36 | | | |
| Temp. B1 | Temp. B2 | Temp. B3 | Temp. B4 | Temp. Tip | Temp Hot | Temp. Hot |
| 239 C. | 245 C. | 250 C. | 250 C. | 250 C. | Run Body | Runner Tip |
| | | | | | 250 C. | 250 C. |

Where “Rate” is the linear injection speed of the screw for the four different rate controlled stages, “End step” is the displacement of the screw for the given injection speed at the appropriate stage, “Hold Pressure” is the amount of hydraulic pressure exerted during the various pressure controlled stages; “Hold Time” is the amount of time the “Hold Pressure” is enacted at the various pressure controlled stages, “Dosage” is the volume of material injected or shot size, “Back Pressure” is the amount of pressure exerted against the screw as the screw is refilled post injection, “Decomp. Flow” is the linear speed at which the screw is retracted once injection of the material has taken placed, “Decomp. Vol.” is the amount of volume decompressed in the screw once injection of the material has taken place, “Cycle time” is the total cycle time required to inject the material, cool the material, eject the material, refill the screw, and close the mold, “Temp.” are the set point temperatures for the various extruder sections, the hot runner, and hot tip, and “Peak Injection Pressure” is the peak hydraulic pressure experienced during the aforementioned cycle.

How well a particular polyethylene material injection molds is determined by comparing the peak injection pressures for all the polyethylene materials. The peak injection pressure is a limiting factor in rapidly filling a mold. Materials with higher peak injection pressure for a given injection speed and temperature will be more difficult to process on similar multi-cavity equipment (i.e. have poor shear thinning characteristics). Material D is a standard injection molding material that has been successfully utilized in multi-cavity injection equipment on a commercial scale in numerous applications. As such, the peak injection pressure for this material, namely 340 bar, is used as a standard of commercial mold conditions in multicavity equipment with a similar preform geometry. Materials with a peak injection pressure within 40% of 340 bar (476 bar) are labeled as having “good” shear thinning characteristics. This means they are suitable for injection molding. The results are summarized in Table 3.

TABLE 3

| Material | 1 | 2 | A | B | C | D |
|---|---|---|---|---|---|---|
| Peak | 370 | 460 | 730 | 500 | 570 | 340 |
| Pressure | | | | | | |
| (bar) | | | | | | |
| Injection | Good | Good | Poor | Poor | Poor | Good |
| mold | | | | | | |

### Stretch Blow Molding

The ability to stretch a preform was assessed by stretching the preforms of FIGS. 1A and 1B made of polyethylene materials described in Table 1, using a Sidel SBO machine. Routine optimization of stretch parameters for each polyethylene material was conducted in order to produce the best bottle. This optimization is a routine step performed for any polyethylene material. Those skilled in the art would be able to perfume this routine optimization without any inventive activity. Parameters to optimize include reheat temperature profile and blow pressure. Once optimal conditions had been achieved for each material, at least 200 bottles from performs were produced. Materials were classified as “good” if they met two requirements. First, the material had to produce bottles without any holes in the walls, neck or base. Second, the material had to produce bottles with a minimum thickness in all areas of the bottle. Materials were labeled as having “poor” strain hardening otherwise.

The presence of holes in the walls, neck or base of the final container was assessed visually. Thickness variability was measured using a Magna Mike. This standard test method uses a 3.2 mm diameter magnet ball with the container. The Magna Mike apparatus then also contains a magnet which attracts the magnetic ball on the inside of the container. The user can then move the Magna Mike device around the container and it measures the thickness of the wall dependent on the difference in magnetic attraction between the ball and sensor. It is preferable to achieve a minimum thickness of 0.2 mm for any part of the container, when the container has an overall weight of 24 g. This ensures structural integrity. Any containers which did not achieve a minimum thickness of 0.2 mm, were labeled as having poor material distribution. Results can be seen in Table 4.

TABLE 4

| | | | Material | Overall |
|---|---|---|---|---|
| Resin | % with holes | | Distribution | Strain Hardening |
| Material 1 | 0% | (0/230) | Good | Good |
| Material 2 | 0% | (0/350) | Good | Good |
| Material A | 0% | (0/200+) | Good | Good |
| Material B | 0.4% | (1/282) | Poor | Poor |
| Material C | 8.5% | (17/200) | Poor | Poor |
| Material D | 65% | (200/300) | Poor | Poor |

### Environmental Stress Crack Resistance

Environmental stress crack resistance was tested on sealed injection stretch blow molded bottles filled with liquid detergent at 49° C. (120° F.) with 4.5 kgf (10 lb_{f}) applied top load. The bottles were monitored for leaks over a period of four weeks. If bottles did not leak after a period of four weeks, then the material is said to be “good” for environmental stress crack resistance (“poor” otherwise). Results can be seen in Table 5.

TABLE 5

| | Environmental stress |
|---|---|
| Material | crack resistance |
| Material 1 | Good |
| Material 2 | Good |
| Material A | Good |
| Material B | Good |
| Material C | Good |
| Material D | Poor |

### Mechanical Properties

Containers made using injection stretch blow molding from preforms according to the present invention, exhibited improved top load resistance as compared to containers made using extrusion blow molding, from standard extrusion blow molding materials. Top load resistance tests were conducted according to ASTM International, D2659-95, using a constant speed of compression of 12.7 mm/min. Top load required to cause a 4 mm displacement in any part of the container (or crushing yield load) and the maximum top load (crushing load at failure) were tested. Results can be seen in Table 6. As can be seen from Table 6, containers made according to the present invention had increased top load resistance to a reference container made by extrusion blow molding.

TABLE 6

| Polyeth- | Top Load needed | | | |
|---|---|---|---|---|
| ylene | to cause 4 mm | Max Top | Container | Dominant |
| material | displacement(kg) | Load (kg) | Weight (g) | Failure Mode |
| 1 ISBM | 25.3 | 27.0 | 29.9 | Crushed Bottom |
| | | | | Corners |
| 2 ISBM | 24.3 | 27.2 | 29.9 | Crushed Bottom |
| | | | | Corners |
| EBM | 19.7 | 19.7 | 31.3 | Failure at Neck |

Injection stretch blow moulding of polyethylene has the advantage of achieving better mechanical properties through molecular orientation. Polyethylene is typically used in the Extrusion Blow Molding process to produce large three-dimensional containers. These extrusion blow molded polyethylene containers lack significant molecular orientation due to the fact that they are stretched well above the melting temperature of the material. Because injection stretch blow molding occurs at lower temperatures, molecular orientation can be locked and maintained into the solid state. In the best case scenario, the injection stretch blow molding process can produce similar bottles to extrusion blow molding with a 25% decrease in material usage. Thus, injection stretch blow molding offers a more economical and efficient method of making three-dimensional containers.

### SUMMARY

Table 7 summarizes the data as described above. As can be seen, only the materials of the present invention have good shear thinning characteristics, produce preforms that have good strain hardening characteristics and produce final containers with good environmental stress crack resistance. All other preforms are ‘poor’ for at least one of injection molding, stretch blow molding or environmental stress crack resistance.

TABLE 7

| | Injec- | | Environmental | | | |
|---|---|---|---|---|---|---|
| | tion | | stress crack | Overall | | |
| Material | mold | Stretch | resistance | Rating | Mz | Mz/Mn |
| Material 1 | Good | Good | Good | Good | 500,000 | 31.1 |
| Material 2 | Good | Good | Good | Good | 740,000 | 31.2 |
| Material A | Poor | Good | Good | Poor | 740,000 | 18.8 |
| Material B | Poor | Poor | Good | Poor | 190,000 | 7.9 |
| Material C | Poor | Poor | Good | Poor | 270,000 | 10.9 |
| Material D | Good | Poor | Poor | Poor | 220,000 | 11.4 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid preform made from polyethylene material, wherein the preform comprises a neck region, side walls and a base region, and has an interior having inner walls and an exterior having outer walls; characterised in that at least about 65% of the polyethylene material by weight of the total polyethylene material has a Z-average molecular weight (Mz) of between about 300,000 g/mol and about 6,000,000 g/mol, and a Mz/Mn value of greater than about 28, where Mn is the number average molecular weight, and Mz/Mn is the Mz value divided by the Mn value.

2. A solid preform according to claim 1 wherein the polyethylene material has a density of from about 0.926 to about 0.960 g/cm³.

3. A solid preform according to claim 1, wherein the polyethylene material comprises a polyethylene material comprising an additive, the additive selected from the group comprising colourant, UV filter, Opacifier, antioxidants, processing aids or mixtures thereof.

4. A process for injection molding a solid preform, wherein the solid preform is made from polyethylene material, and wherein the preform comprises a neck region, side walls and a base region, and has an interior having inner walls and an exterior having outer walls; characterised in that at least about 65% of the polyethylene material by weight of the total polyethylene material has a Z-average molecular weight (Mz) of between about 300,000 g/mol and about 6,000,000 g/mol, and a Mz/Mn value of greater than about 28, where Mn is the number average molecular weight, and Mz/Mn is the Mz value divided by the Mn value, and the peak pressure during the injection molding process is less than about 500 bar.

5. A process for blow molding a polyethylene container comprising the steps of:
a) providing a solid preform made from a polyethylene material, wherein the preform comprises a neck region, side walls and a base region, and has an interior having inner walls and an exterior having outer walls;
b) optionally reheating the preform so that the maximum temperature difference between the hottest and coldest regions of the side walls and the base region of the reheated preform is less than about 4° C.;
c) transferring the preform to a blow mould cavity;
d) stretching the preform at a pressure below about 15 bars; and
e) increasing the pressure within the reheated preform so as to cause the walls of the stretched preform to expand to the shape and dimensions inside the blow mould cavity;
characterised in that at least about 65% of the polyethylene material by weight of the total polyethylene material has a Z-average molecular weight (Mz) of between about 300,000 g/mol and about 6,000,000 g/mol, and a Mz/Mn value of greater than about 28, where Mn is the number average molecular weight, and Mz/Mn is the Mz value divided by the Mn value.

6. A process according to claim 5 wherein the preform is stretched by means of a stretch rod at a speed greater than about 1 m/s.

7. A process according to claim 5 wherein the preform is formed in step a) by a process selected from injection molding, extrusion blow molding and compression molding.

8. A process according to claim 5 wherein the preform is reheated in step b), and wherein the maximum temperature difference between the hottest and coldest regions of the side walls and the base region of the reheated preform is less than about 2° C.

9. A polyethylene container made according to the process of claim 5.
